(19) United States
(12) Patent Application Publication
(10) Pub. No.: US 2024/0112062 A1
(43) Pub. Date: Apr. 4, 2024

(54) QUANTUM CIRCUIT SERVICE

(71) Applicant: Amazon Technologies, Inc., Seattle, WA (US)

(72) Inventors: Saravanakumar Shanmugam Sakthivadivel, New York, NY (US); Altanali Nagji, Austin, TX (US); Jeffrey Paul Heckey, Seattle, WA (US); Christian Bruun Madsen, Longmont, CO (US); Denis Antipov, Shoreline, WA (US); Ravi Kiran Chilakapati, Mill Creek, WA (US)

(73) Assignee: Amazon Technologies, Inc., Seattle, WA (US)

(21) Appl. No.: 17/937,409

(22) Filed: Sep. 30, 2022

(51) Int. Cl. G06N 10/80; G06F 9/50; G06N 10/20

(52) U.S. Cl. CPC G06N 10/80; G06F 9/5027; G06N 10/20

(57) ABSTRACT

A system for managing deployment of quantum circuits is described. The system may include a web server configured to receive, from a consumer, a quantum computing request to perform a job using a given quantum application. The web server may generate a response based on execution of the quantum application and at least a portion of the quantum computing request and return the response to the consumer. The system may also include a deployment service configured to store quantum circuit definitions in a data store. The deployment service may receive, from the web server, a deployment request for executing a quantum circuit. The deployment service may generate a container for implementing the quantum circuit. The deployment service may configure a quantum application in the container for executing a job using the quantum circuit. The deployment service may provide the web server access to results of the execution of the job.

### BACKGROUND

Cloud computing service providers may offer remote access to computing resources. The computing resources may be configured to execute computer code on behalf of various clients on-demand. The computing resources may be provisioned in response to client requests. The computing resources may be provisioned as virtual machines that use logically implemented hardware to execute the computer code. Quantum computing resources may also be provided by the cloud computing service to process information to solve computational algorithms that would not be efficiently solved by classical computing resources.

Quantum computers utilize the laws of quantum physics to process information. Compared to classical (binary) computers, quantum computers work with quantum bits (or qubits). Qubits can experience the phenomena of “superposition” and “entanglement.” Superposition allows a qubit to be in multiple states at the same time. For example, whereas a classical computer is based on bits that are either zero or one, a qubit may be both zero and one at the same time, with different probabilities assigned to zero and one. Entanglement is a strong correlation between qubits, such that the qubits are inextricably linked in unison even if separated by great distances. By using superposition and entanglement, quantum computers have the potential to process information in new ways to solve computational problems that are beyond the reach of classical computers.

### BRIEF DESCRIPTION OF THE DRAWINGS

FIG. 1 is a block diagram showing an example provider network that includes a quantum circuit publishing service, a published quantum circuit deployment service, an algorithm execution management system, and other associated provider network services, according to some embodiments.

FIG. 2 is a diagram showing example contents of a container that may be used to implement a published quantum circuit, and the figure also shows interactions between the container and an algorithm execution management system via an application programming interface (API), according to some embodiments.

FIG. 3 is a diagram showing example types of containers that may be used to implement published quantum circuits, according to some embodiments.

FIG. 4 is a block diagram showing an example quantum computing service of a provider network that may orchestrate deployment of a published quantum circuit, according to some embodiments.

FIG. 5 is a block diagram showing an example provider network including a quantum circuit publishing service, a published quantum circuit deployment service, an algorithm execution management system, and other cloud-based services, according to some embodiments.

FIG. 6 is a logical block diagram illustrating interactions to publish a quantum circuit using a published quantum circuit deployment service and a web server, according to some embodiments.

FIG. 7 is a logical block diagram illustrating interactions to execute a published quantum circuit using a published quantum circuit deployment service and an algorithm execution management system, according to some embodiments.

FIG. 8 is a flowchart illustrating an example method for executing a published quantum circuit using different computing resources, according to some embodiments.

FIG. 9 is a flowchart illustrating another example method for executing a published quantum circuit using different computing resources, according to some embodiments.

FIG. 10 is a block diagram showing an example classical computing device that may be used to implement various ones of the techniques described herein, according to some embodiments.

While embodiments are described herein by way of example for several embodiments and illustrative drawings, those skilled in the art will recognize that the embodiments are not limited to the embodiments or drawings described. It should be understood that the drawings and detailed description thereto are not intended to limit embodiments to the particular form disclosed, but on the contrary, the intention is to cover all modifications, equivalents and alternatives falling within the spirit and scope as defined by the appended claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

### DETAILED DESCRIPTION

Various embodiments described herein relate to publishing a quantum circuit in a way that allows users of the published quantum circuit to execute quantum jobs using the quantum circuit without needing to manage compiling of the quantum circuit, reserving quantum resources to execute the compiled quantum circuit, or managing execution of the compiled quantum circuit. For example, a provider network may provide services to clients relating to on-demand access to the quantum computing resources, according to various embodiments. A deployment service may incorporate the algorithm into a container for execution at the classical computing resources or the quantum computing resources. In some embodiments, the container may include code of the algorithm, associated libraries or dependencies for executing the algorithm at the classical computing resources, runtime environments (e.g., software or instructions that are executed while the algorithm is executed), and/or system tools and settings (e.g., environment variables). The container may provide a compute environment for which the algorithm may be executed at the classical computing resources or the quantum computing resources.

For example, the container for executing the algorithm may be provided to the quantum computing resources to provision the quantum computing resources in response to a request. In some implementations, the provider network may provide additional services to the clients who in turn may provide access to the clients' quantum algorithms to customers of the clients. In some situations, the clients of the provider network may be considered to be publishers of respective algorithms to consumers who may request execution of the algorithms to generate data sets.

The publisher may offer to consumers access to execution of the algorithm via a web service. The web service may be configured to provide access to the container via the Internet. For example, the web service may be implemented by a web server that provides access to the web service via a uniform resource identifier (URI) or a uniform resource locator (URL). In some implementations, the web service may send a request to the deployment service for deployment of a given quantum circuit to the quantum computing resources for execution on behalf of the web service.

In one aspect, a system is described. The system may include a web server and a deployment service. The web server may be configured to receive, from a consumer via a web service, a quantum computing request to perform a job using a given quantum application. The web server may be configured to generate a response based at least in part on execution of the quantum application and at least a portion of the quantum computing request. The web server may also be configured to return the response to the consumer. The deployment service may be configured to store one or more quantum circuit definitions in a data store. The deployment service may be configured to receive, from the web server, a deployment request for deploying executing a quantum circuit defined by a given one of the one or more quantum circuit definitions. The deployment service may be configured to generate a container for implementing the quantum circuit having the given quantum circuit definition. The deployment service may be configured to configure a quantum application in the container for executing a job using the quantum circuit having the given quantum circuit definition. The deployment service may be configured to provide the web server access to results of the execution of the job using the quantum circuit.

The consumer may access the web service according to the URI or URL. The consumer may execute the algorithm provided by the publisher. In response to a request from the consumer, the quantum computing resources may execute the algorithm according to any inputs that may be provided by the consumer or the publisher to generate an output of the algorithm. The output may be provided to the consumer subject to any post-processing functions that may be applied to the output.

In another aspect, a method is described. The method may include receiving, by a quantum circuit deployment service, a deployment request for executing a quantum circuit defined by a quantum circuit definition, wherein the quantum circuit definition is one of a plurality of quantum circuit definitions maintained by the quantum circuit deployment service. The method may also include generating a container for implementing the quantum circuit having the quantum circuit definition. The method may further include configuring a quantum application in the container for executing a job using the quantum circuit having the quantum circuit definition. The method may also include providing access to results of the execution of the job using the quantum circuit.

In yet another aspect, one or more computer-readable storage media are described. The computer-readable storage media may store instructions that, when executed on or across one or more processors, cause the one or more processors to perform operations of a quantum circuit deployment service. The quantum circuit deployment service may in response to a deployment request from a web server for executing a quantum circuit defined by a quantum circuit definition, generate a container for implementing the quantum circuit having the quantum circuit definition, wherein the quantum circuit definition is one of a plurality of quantum circuit definitions maintained by the quantum circuit deployment service. The quantum circuit deployment service may configure a quantum application in the container for executing a job using the quantum circuit having the quantum circuit definition. The quantum circuit deployment service may provide access to results of the execution of the job using the quantum circuit.

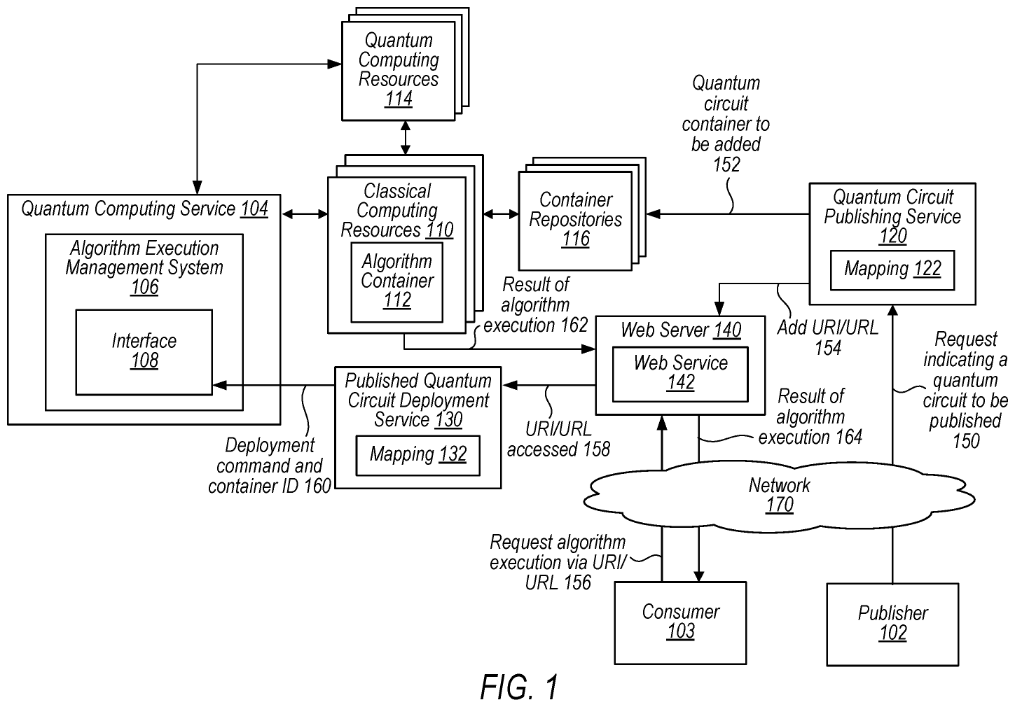

FIG. 1 illustrates a system 100 for managing algorithm execution on or across classical computing resources and quantum computing resources, according to some embodiments. The system 100 may be configured to provide services to clients, including a publisher 102 and a consumer 103, according to some embodiments. The system 100 may include one or more computing devices configured to provide services to the clients. The services may include a quantum computing service 104, a quantum circuit publishing service 120, and a published quantum circuit deployment service 130, according to some embodiments. The system 100 may also include a web server 140 comprising one or more computing devices configured to implement a web service 142, according to some embodiments. In some embodiments, the system 100 may include a provider network that includes computing devices configured to provide services to clients over network 170.

The system 100 may execute algorithms on or across computing resources. In some embodiments, the computing resources may include classical computing resources 110 and quantum computing resources 114. For example, the algorithms may include hybrid algorithms that are executed across the classical computing resources 110 and the quantum computing resources 114.

An algorithm execution management system 106 may include an interface 108, through which the published quantum circuit deployment service 130 may access algorithm execution management system 106 and/or quantum computing service 104. In some embodiments, user interface 108 may include an application programming interface (API). In some embodiments, network 170 may include wired and/or wireless network connections. In some embodiments, provider network may also provide consumer 103 or publisher 102 access to various computing resources, such as one or more classical computing resources 110 and one or more quantum computing resources 114. In some embodiments, classical computing resources 110 may include various computing resources based on binary bits, such as classical (binary) computers, GPUs, ASICs, etc. By comparison, quantum computing resources 114 may include various quantum computers, quantum processing units (QPUs), and/or quantum hardware based on qubits. In some embodiments, quantum computing resources 114 may be implemented using qubits built from superconductors, trapped ions, semiconductors, photonics, etc.

The publisher 102 may send to a quantum circuit publishing service 120 a request 150 indicating a quantum circuit to be published, according to some embodiments, including classical computing resources 110 and quantum computing resources 114. In some embodiments, request 150 may indicate a quantum circuit container 152 to be added. In some embodiments, the container may be stored to container repositories 118 of provider network. The container 152 may be a package of software that includes the algorithm code and its dependencies so that the algorithm code may be portable and executable from one classical computing resource 110 to another. For example, in some embodiments, the container 152 may include the code of the algorithm (which may be included in one or more script files), one or more associated libraries for executing the algorithm, runtime (e.g., software or instructions that are executed while the algorithm is executed), and/or one or more system tools and settings (e.g., environment variables). In some embodiments, the request 150 may also indicate an execution environment for the quantum circuit. For example, the request 150 may indicate that the quantum circuit is to be executed on quantum hardware. As another example, the request 150 may indicate that the quantum circuit is to be executed on a quantum compute simulator using classical hardware.

Like virtual machines, a container also provides resource isolation and allocation benefits—e.g., applications (e.g., algorithms) can be executed within a compute environment (provided by the container) that are isolated from each other. Whereas, virtual machines require hypervisors to be installed on the host machine, and multiple virtual machines can then run on the same hypervisor of the host machine, and each virtual machine includes a full copy of an OS (also called the guest OS) that can be different from the OS of the host machine. By comparison, containers may not necessarily require hypervisors, but may operate on virtual machines operated by hypervisors. Multiple containers may run on the same host machine and share the OS of the host machine, each running as an isolated process in its own space. As a result, containers generally take up less space than VMs (because they do not include a copy of an OS). More importantly, containers may be considered a standalone and portable software package that can be executed from one host machine to another. Given the characteristics of containers, the container 152 may thus provide a containerized compute environment within which the algorithm may be executed at classical computing resources 110. In some embodiments, the container 152 may be moved between virtual machines, for example due to processing requirements, without having to re-configure the contents of the container.

The quantum circuit publishing service 120 may generate the container 152 one or more pre-configured containers offered by the provider network. For example, in some embodiments, the publisher 102 may create the container 152 with the quantum circuit publishing service 120. In some embodiments, algorithm execution management system 106 may provide one or more pre-configured containers that includes example codes and libraries. The system 100 may also include one or more container repositories 118 that store one or more pre-configured containers that may be used as templates to create a container, such as container 112, to execute the algorithm. In some embodiments, container repositories 118 may be implemented as one or more data stores. In some embodiments, the publisher 102 may select one of the pre-configured containers to create the container. In some embodiments, the publisher 102 may further store the created container at container repositories 118 of provider network. Therefore, when published quantum circuit deployment service 130 provides a deployment command 160 that includes a container identifier, the quantum computing service 104 may indicate the container identifier to identify the container 112. Accordingly, algorithm execution management system 106 may cause the classical computing resources 110 to retrieve the container 112 for executing the algorithm.

In some embodiments, the code of the algorithm in the container may be composed as script files using quantum computing languages, such as Quil, Open QASM, cQASM, etc. In addition, in some embodiments, the code may be composed as graphic diagrams files that include quantum gates. In some embodiments, the quantum circuit publishing service 120 may cause the code to be converted into executable code for execution at classical computing resources 110 and quantum computing resources 114. In some embodiments, the conversion may include first translating the code into quantum gates, and then compiling the quantum gates into executable code. In some embodiments, the conversion may be performed at algorithm execution management system 106 and/or quantum computing service 104.

Quantum circuit publishing service 120 may also map quantum circuit container 152 to a uniform resource identifier (URI) or uniform resource locator (URL) according to mapping 122. For example, mapping 122 may include data records indicating that respective quantum circuit containers to respective URIs. In some embodiments, quantum circuit publishing service 120 may add 154 the URI to web server 140. For example, the added URI may direct consumers to web service 142 that facilitates access to container 152 as managed by algorithm execution management system 106, such as algorithm container 112. The URI may be accessible by consumers, such as consumer 103.

Consumer 103 may send, to web server 140, request 156 for executing an algorithm via the URI, according to some embodiments. For example, consumer 103 may access the web service based on the URI. Consumer 103 may interact with the web service to request that the algorithm based on container 152 be executed. Web server 140 may respond to request 156 by indicating to published quantum circuit deployment service 130 that the URI has been accessed 158. In some embodiments, published quantum circuit deployment service 130 may send a request to published quantum circuit deployment service 130 to cause deployment of container 152.

Published quantum circuit deployment service 130 may send, to algorithm execution management system 106, a deployment command 160 that may include a container identifier for container 152, according to some embodiments. The container identifier may indicate to algorithm execution management system 106 that container 152 is to be deployed to classical computing resources 110 and quantum computing resources 114 for execution of the algorithm, according to some embodiments.

In response to deployment command 160, algorithm execution management system 106 may cause respective portions of the algorithm of container 152 be deployed to respective computing resources. For example, algorithm execution management system 106 may send a classical portion of the algorithm 152 to classical computing resources 110 and send a quantum portion of the algorithm to quantum computing resources 114. As another example, algorithm execution management system 106 may send container 152 to classical computing resources 110 such that classical computing resources 110 may send the quantum portion to quantum computing resources 114. In some embodiments, algorithm execution management system 106 may cause the quantum circuit container 152 to be sent from container repositories 116 to classical computing resources 110.

Classical computing resources 110 may execute classical portion 614, and quantum computing resources 114 may execute quantum portion 616, according to some embodiments. For example, classical computing resources 110 and quantum computing resources 114 may generate results of algorithm execution. In some embodiments, classical computing resources 110 and quantum computing resources 114 may send results to algorithm execution management system 106. In some embodiments, results may be incorporated into the container for subsequent retrieval by consumer 103. In other embodiments, results may be incorporated into container 112 for subsequent executions of the algorithm.

Algorithm execution management system 106 may send results to web server 140 based on results provided by classical computing resources 110 and quantum computing resources 114, according to some embodiments. In some situations, post-processing code included in container 112 may modify at least a portion of the results to generate finalized results. For example, particular ranges of results may be removed. As another example, particular types of results may be filtered.

Web server 140 may provide results 162 of algorithm execution to consumer 103 based on results provided by algorithm execution management system 106, according to some embodiments. For example, web server 140 may generate a user interface to display results to consumer 103. As another example, web server 140 may send one or more files that include results 162.

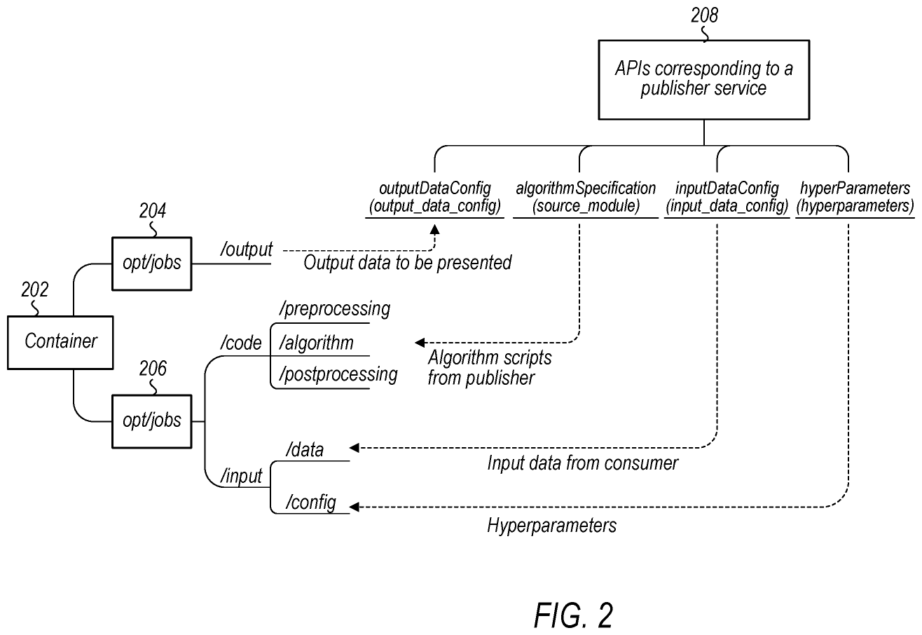

FIG. 2 shows example contents of a container and interactions between the container and an algorithm execution management system via an application programming interface (API), according to some embodiments. In FIG. 2, in some embodiments, container 202 may include one or more folders, such as folder 204 “opt/jobs/output” and folders 206 “opt/jobs/code,” “opt/jobs/input/data,” “opt/jobs/input/config,” and/or “opt/jobs/checkpoints.” In some embodiments, folder 204 “opt/jobs/output” may refer to a local folder within container 202 for saving data created from execution of the algorithm. For example, the data may include the result of the algorithm when the execution completes or is paused at a checkpoint. Further, container 202 may be associated with a variable “output_data_config” whose value may be specified. Based on the value of the variable “output_data_config,” application programming interface (API) 208 corresponding to a publisher service (e.g., quantum circuit publishing service 120) may use the variable “output_data_config” to copy the data from folder 204 “opt/jobs/output” of container 202 to a location, e.g., a web server of a provider network, specified by the variable “output_data_config” or a default location if the value is not specified.

In some embodiments, folder 206 “opt/jobs/code” may specify a local folder within container 202 into which the algorithm code may be copied, e.g., by API 208, from a data store of the provider network as specified by the variable “source_module.” For example, as described above, in some embodiments, container 202 may be created based on a preconfigured container provided by the provider network. Thus, the algorithm code may have been available at a location in the provider network, and thus may be copied from the location to folder 206 “opt/jobs/input.” Alternatively, in some embodiments, container 202 may be created by a user without using a preconfigured container provided by the provider network. In that case, the algorithm code may still have been provided by the user and stored at a location in the provider network. Alternatively, in some embodiments, the algorithm code may be originally included in container 202, rather than copied from (the location) of the provider network. The algorithm code may also include pre-processing code and post-processing code configured to apply various functions to inputs before or after the algorithm code, respectively.

Similarly, in some embodiments, container 202 may include folders 206 “opt/jobs/input/data” and/or “opt/jobs/input/config” that may refer to local folders within container 202 into which input data and/or other configuration data may be copied, e.g., by API 208, from locations or data stores of the provider network specified respectively by the variables “input_data_config” and/or “hyperparameters.” For example, when the algorithm includes training of a machine learning model, the input data may include training and/or testing data sets, and the configuration data may include hyperparameters for the machine learning model.

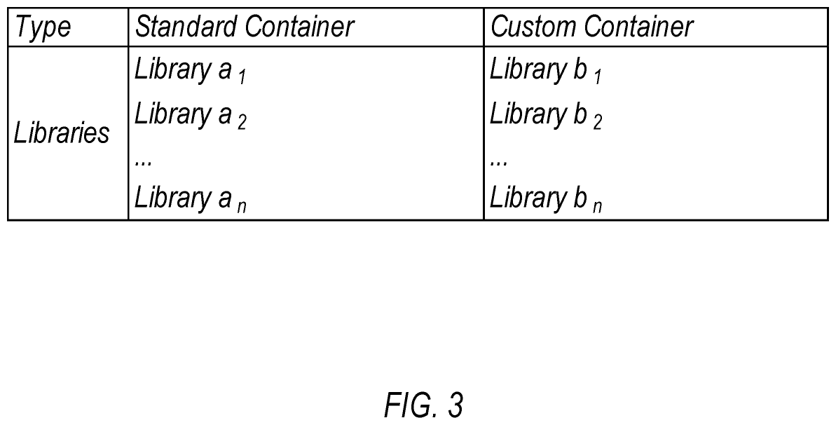

FIG. 3 shows example types of containers, according to some embodiments. In some embodiments, a standard container may correspond to a default type container that is supported by an algorithm execution management system of a provider network. Accordingly, a standard container may require one or more libraries, such as library a1, a2, . . . , an for executing an algorithm code within the compute environment provided by the standard container. In some embodiments, the algorithm execution management system may also support other types of containers, such as a custom container. In some embodiments, the custom container may be created using third-party and/or open-source environment libraries that are not necessarily originated by the provider network. For example, the custom container may be a container with TensorFlow, PyTorch, etc. libraries. In some embodiments, the custom container may need some of the same libraries as the standard container, or may require some different libraries. For purposes of illustration, in FIG. 3, the custom container may require libraries such as library b1, b2, . . . , bn.

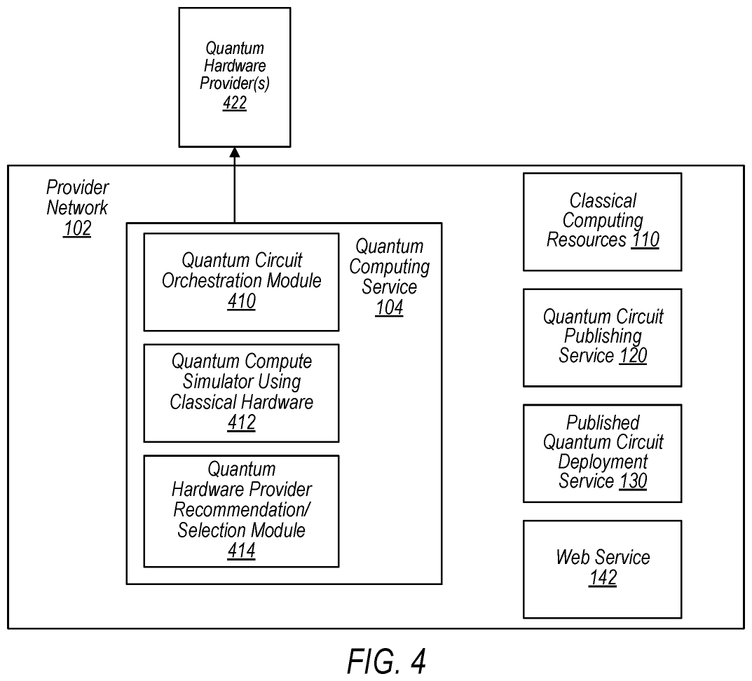

FIG. 4 shows an example quantum computing service of a provider network, according to some embodiments. In FIG. 4, provider network 402 may include quantum computing service 104, which may provide consumers or publishers access to various quantum computing resources offered by quantum hardware providers 422. As indicated in FIG. 4, quantum hardware providers 422 may provide various different types of quantum computing resources. In some embodiments, quantum computing service 104 may include translation module 412. Quantum computing service may include a quantum circuit orchestration module. The quantum circuit orchestration module may include an algorithm execution management system that receives request 118 indicating a container that include algorithm code and dependencies and a translation module may translate the code to gate-level code.

In some embodiments, quantum computing service 104 may include a back-end API transport module. Algorithms that have been translated by the translation module (to a native language) may be provided to a back-end API transport module in order for the translated algorithms to be compiled into executable code and transported to quantum computing resources 114 at a respective quantum hardware provider location for execution. In some embodiments, the back-end API transport module may implement one or more queues to queue the translated algorithm for execution on quantum computing resources 114 of the quantum hardware provider. In some embodiments, the algorithm may be transmitted via a back-end API transport module and later compiled at a quantum hardware provider.

In some embodiments, results of executing the algorithm on quantum computing resources 114 at the quantum hardware provider location may be stored in a data storage system of the provider network. In some embodiments, quantum circuit orchestration module 410 may include a results storage/results notification module that may coordinate storing results and may notify consumer 103 that the results are ready from the execution of the user's algorithm. In some embodiments, the results storage/results notification module may cause storage space in a data storage service to be allocated to publisher 102 to store the algorithm's results. Also, the results storage/results notification module may specify access restrictions for viewing the user's results in accordance with user preferences.

In some embodiments, quantum compute simulator using classical hardware 412 of quantum computing service 104 may be used to simulate an algorithm using classical hardware. For example, one or more virtual machines of a virtual computing service may be instantiated to process an algorithm simulation job. In some embodiments, publisher 102 may use a container (e.g., the container 152) to request an algorithm to be simulated. In that case, the simulation may involve multiple classical computing resources, where some may be used to simulate quantum computing and the others may be used as a co-processor to process the classical computing. In some embodiments, quantum compute simulator using classical hardware 412 may fully manage compute instances that perform the simulation. For example, in some embodiments, publisher 102 may submit an algorithm to be simulated and quantum compute simulator using classical hardware 412 may determine resources needed to perform the simulation job, reserve the resources, configure the resources, etc. In some embodiments, quantum compute simulator using classical hardware 412 may include one or more “warm” simulators that are pre-configured simulators such that they are ready to perform a simulation job without a delay typically involved in reserving resources and configuring the resources to perform simulation.

In some embodiments, quantum computing service 104 includes quantum hardware provider recommendation/selection module 414. As described above, in some embodiments, publisher 102 may specify quantum computing resources 114 to be used for executing the algorithm. For example, publisher 102 may specify quantum computing resources 114 using an environment variable. Alternatively, in some embodiments, algorithm execution management system 106 may use quantum hardware recommendation/selection module 414 to make a recommendation to publisher 102 as to which type of quantum computer or which quantum hardware provider to use to execute a quantum program submitted by the publisher 102. Additionally, quantum hardware provider recommendation/selection module 414 may receive a user selection of a quantum computer type and/or quantum hardware provider to use to execute the publisher 102's quantum program.

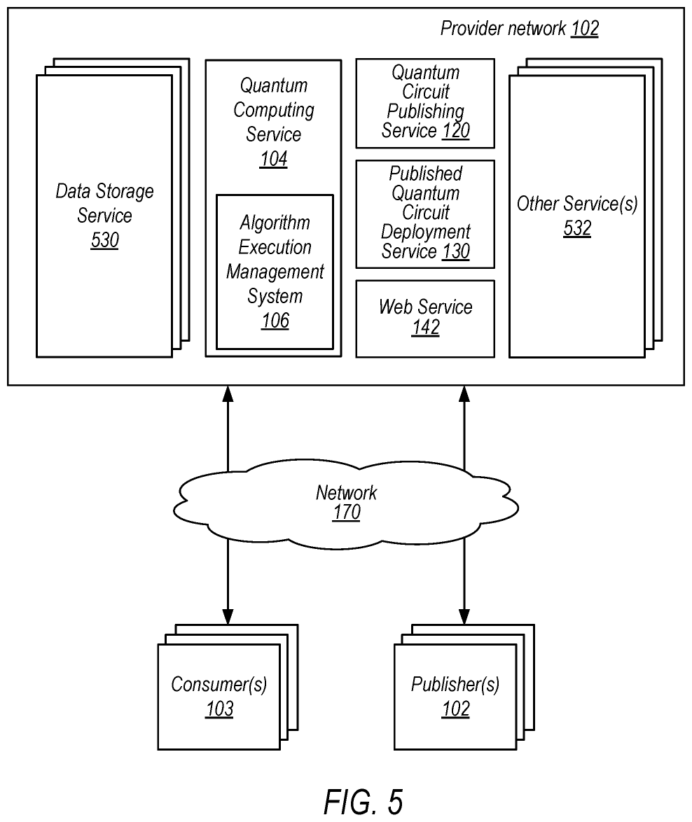

FIG. 5 is a block diagram showing an example provider network including an algorithm execution management system and other cloud-based services, according to some embodiments. In some embodiments, the provider network may be a private or closed system or may be set up by an entity such as a company or a public sector organization to provide one or more services (such as various types of cloud-based storage) accessible via network 170 to one or more clients 504. Provider network 502 may be implemented in a single location or may include numerous data centers hosting various resource pools, such as collections of physical and/or virtualized computer servers, storage devices, networking equipment and the like, needed to implement and distribute the infrastructure and storage services offered by provider network 104. In some embodiments, provider network 502 may implement various network-accessible services, such as quantum computing service 104, data storage service 530, quantum circuit publishing service 120, published quantum circuit deployment service 130, web service 142, and one or more other services 532, as indicated in FIG. 5. In some embodiments, provider network 502 may further include algorithm execution management systems 106. In this example, algorithm execution management system 106 may be implemented as part of quantum computing service 104. Alternatively, in some embodiments, algorithm execution management systems 106 may be implemented separately from quantum computing service 104, two of which may be operatively coupled with each other via one or more network connections.

In some embodiments, data storage service 530 may implement different types of data stores for storing, accessing, and managing data on behalf of clients 504, such as a publisher or a consumer, as a network-based service that enables one or more clients 504 to operate a data storage system in a cloud or network computing environment. For example, data storage service 530 may include various types of database storage services (both relational and non-relational) or data warehouses for storing, querying, and updating data. Such services may be enterprise-class database systems that are scalable and extensible. Queries may be directed to a database or data warehouse in data storage service 530 that is distributed across multiple physical resources, and the database system may be scaled up or down on an as needed basis. The database system may work effectively with database schemas of various types and/or organizations, in different embodiments. In some embodiments, users/subscribers may submit queries in a number of ways, e.g., interactively via an SQL interface to the database system. In other embodiments, external applications and programs may submit queries using Open Database Connectivity (ODBC) and/or Java Database Connectivity (JDBC) driver interfaces to the database system.

In some embodiments, data storage service 530 may also include various kinds of object or file data stores for putting, updating, and getting data objects or files, which may include data files of unknown file type. Such data storage service 530 may be accessed via programmatic interfaces (e.g., APIs) or graphical user interfaces. Data storage service 530 may provide virtual block-based storage for maintaining data as part of data volumes that can be mounted or accessed similar to local block-based storage devices (e.g., hard disk drives, solid state drives, etc.) and may be accessed utilizing block-based data storage protocols or interfaces, such as internet small computer interface (iSCSI).

As described above, in some embodiments, provider network 502 may provide clients 504 access to different types of computing resources, such as classical computing resources 110 and quantum computing resources 114. In some embodiments, provider network 502 may use algorithm execution management system 106 to automate and streamline execution of an algorithm for consumer 103 using the different types of computing resources. For example, in some embodiments, algorithm execution management system 106 may receive request 118 from consumer 103for executing an algorithm using the different computing resources. In some embodiments, request 118 may indicate a container that includes algorithm code and libraries for executing the algorithm at classical computing resources 110. In some embodiments, the container may be created by publisher 102 without using a container provided by provider network 502. Alternatively, in some embodiments, the container may be created using a container provided by provider network 502. In embodiments, in response to receiving request 118, algorithm execution management system 106 may determine whether quantum computing resources 114 are available to execute the algorithm. In response to determining that quantum computing resources 114 are available, algorithm execution management system 106 may cause classical computing resources 110 to be provisioned, and instructed at least one portion of the algorithm to be executed at classical computing resources 110 using a compute environment provided by the container and at least another portion of the algorithm to be executed at quantum computing resources 114. In some embodiments, the quantum task of the algorithm may be provided a priority over quantum tasks of other algorithms for using quantum computing resources 114 during execution of the algorithm. In some embodiments, algorithm execution management system 106 may receive a result of the execution of the algorithm from classical computing resources 110 and/or quantum computing resources 114.

Provider network 102 may also include quantum circuit publishing service 120, published quantum circuit deployment service 130, and web service 142. In some embodiments, other service(s) 532 may include various types of computing services. For example, in some embodiments, data processing service 532 may include one or more computing services that may provide clients 504 access to various computing resources at one or more data centers. In some embodiments, the computing resources may include classical computing resources 110, and/or quantum computing resources 114. In some embodiments, the computing services may include an elastic compute cloud service that may offer virtual compute instances (also referred to as virtual machines, or simply “instances”) with varying computational and/or memory resources, which are managed by a compute virtualization service (referred to in various implementations as an elastic compute service, a virtual machines service, a computing cloud service, a compute engine, or a cloud compute service). In some embodiments, other service(s) 332 may include data processing services to perform different functions (e.g., anomaly detection, machine learning, querying, or any other type of data processing operation). For example, in some embodiments, the data processing services may include a map reduce service that creates clusters of processing nodes that implement map reduce functionality over data stored in data storage service 330. Various other distributed processing architectures and techniques may be implemented by data processing services (e.g., grid computing, sharding, distributed hashing, etc.). Note that in some embodiments, data processing operations may be implemented as part of data storage service 330 (e.g., query engines processing requests for specified data).

Generally speaking, clients 504 may encompass any type of client configured to submit network-based requests to provider network 502 via network 170, including requests for executing algorithms using different types of computing resources. For example, a given consumer 103may include a suitable version of a web browser, or may include a plug-in module or other type of code module configured to execute as an extension to or within an execution environment provided by a web browser. Alternatively, clients 504 may encompass an application, such as a quantum computing application with an integrated development environment. In some embodiments, clients 504 may include sufficient protocol support (e.g., for a suitable version of Hypertext Transfer Protocol (HTTP)) for generating and processing network-based services requests without necessarily implementing full browser support for all types of network-based data. That is, clients 504 may include an application configured to interact directly with provider network 502. In some embodiments, clients 504 may be configured to generate network-based services requests according to a Representational State Transfer (REST)-style network-based services architecture, a document- or message-based network-based services architecture, or another suitable network-based services architecture.

In some embodiments, network 170 may encompass any suitable combination of networking hardware and protocols necessary to establish network-based-based communications between clients 504 and provider network 502. For example, network 170 may generally encompass the various telecommunications networks and service providers that collectively implement the Internet. Network 170 may also include private networks such as local area networks (LANs) or wide area networks (WANs) as well as public or private wireless networks. For example, both a given consumer 103 or publisher 102and provider network 502 may be respectively provisioned within enterprises having their own internal networks. In such an embodiment, network 170 may include the hardware (e.g., modems, routers, switches, load balancers, proxy servers, etc.) and software (e.g., protocol stacks, accounting software, firewall/security software, etc.) necessary to establish a networking link between given clients 504 and the Internet as well as between the Internet and provider network 502. It is noted that in some embodiments, clients 504 may communicate with provider network 502 using a private network rather than the public Internet.

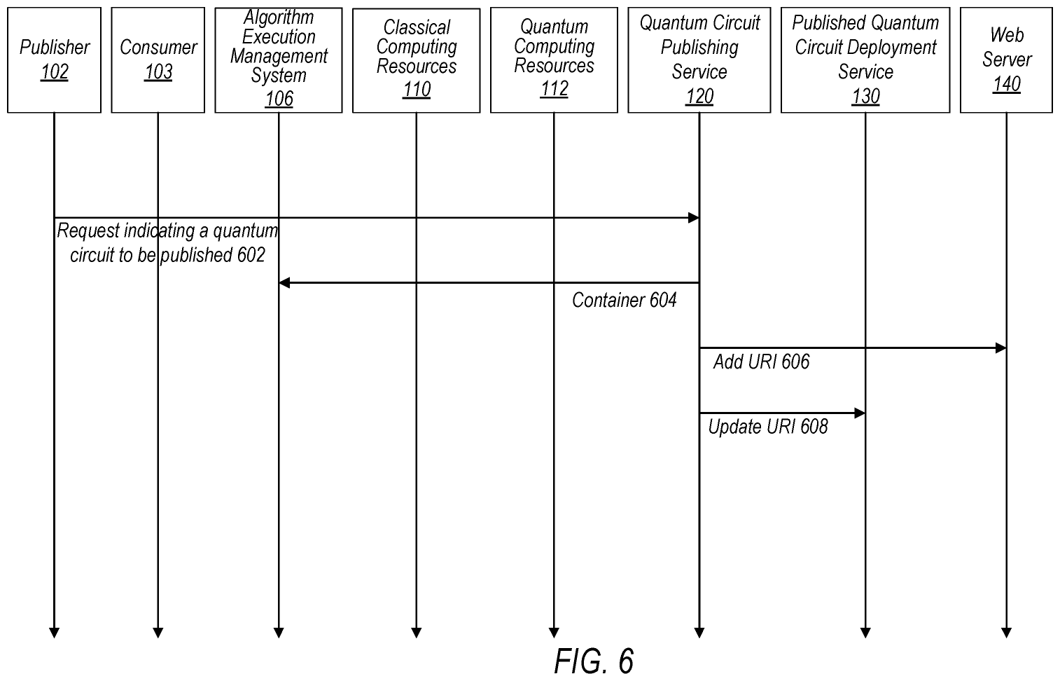

FIG. 6 illustrates a logical block diagram illustrating interactions to publish a quantum circuit to be executed using an algorithm execution management system, according to some embodiments. Different actions may be performed by respective computing devices implemented in a provider network, according to some embodiments.

Publisher 102 may send, to quantum circuit publishing service 120, a request 602 indicating a quantum circuit to be published, according to some embodiments. For example, the quantum circuit may include a quantum circuit definition to be made available to consumers, such as consumer 103. Quantum circuit publishing service 120 may respond to the request 602 by generating container 604 for the quantum circuit. In some embodiments, container 604 may include pre-processing code, the quantum circuit, and post-processing code. Quantum circuit publishing service 120 may send container 604 to a storage destination. For example, the storage destination may include a container repository maintained by algorithm execution management system 106, such as container repositories 116.

Quantum circuit publishing service 120 may also map container 604 to a uniform resource identifier (URI) or uniform resource locator (URL) according to a mapping, such as mapping 122. In some embodiments, quantum circuit publishing service 120 may add 606 the URI to web server 140. Quantum circuit publishing service 120 may also update 608 published quantum circuit deployment service 130 with the URI or URL. For example, the added URI may direct consumers to a web service that facilitates access to container 604 as managed by algorithm execution management system 106. The URI may be accessible by consumers, such as consumer 103.

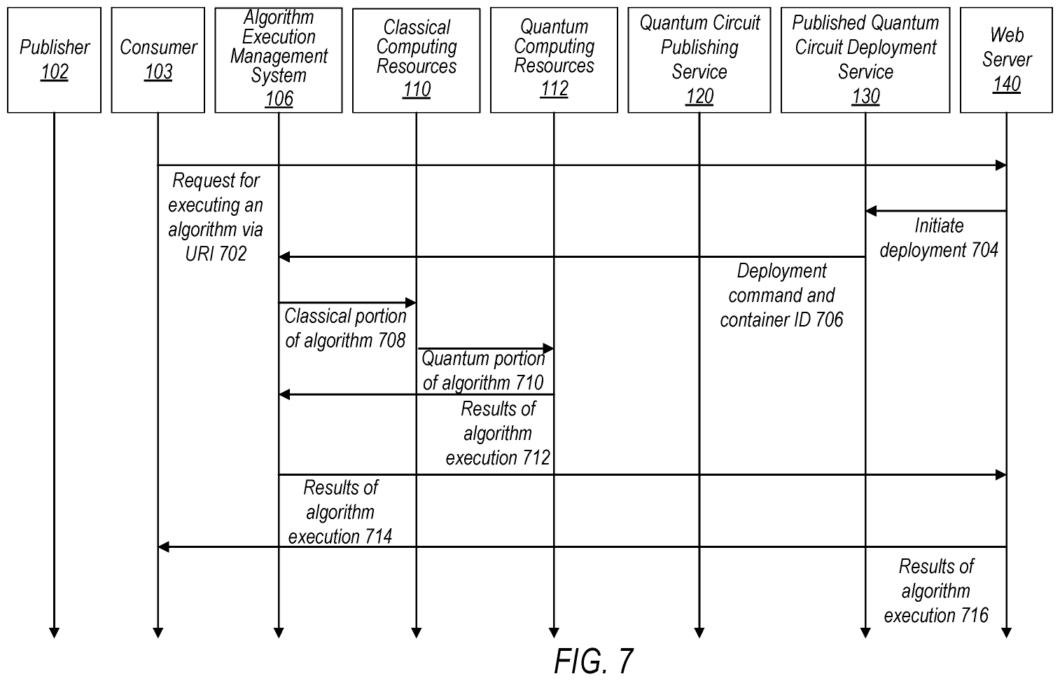

FIG. 7 is a logical block diagram illustrating interactions to execute an algorithm using an algorithm execution management system, according to some embodiments. Different actions may be performed by respective computing devices implemented in a provider network, according to some embodiments.

Consumer 103 may send, to web server 140, request 702 for executing an algorithm via the URI, according to some embodiments. For example, consumer 103 may access the web service based on the URI. Consumer 103 may interact with the web service to request that the algorithm based on container 604 be executed. Web server 140 may respond to request 702 by initiating 704 deployment of a quantum circuit container (e.g., container 604). In some embodiments, initiating 704 may include sending a request to published quantum circuit deployment service 130 to cause deployment of the container.

Published quantum circuit deployment service 130 may send, to algorithm execution management system 106, a deployment command 706 that may include a container identifier for the container, according to some embodiments. The container identifier may indicate to algorithm execution management system 106 that the container is to be deployed to classical computing resources 110 and quantum computing resources 114 for execution of the algorithm, according to some embodiments.

In response to deployment command 706, algorithm execution management system 106 may send respective portions of the algorithm of the container to respective computing resources. For example, algorithm execution management system 106 may send classical portion of the algorithm 708 to classical computing resources 610 and send quantum portion of the algorithm 710 to quantum computing resources 114. As another example, algorithm execution management system 106 may send the container to classical computing resources 110 such that classical computing resources 110 may send quantum portion 710 to quantum computing resources 114. In some implementations, a virtual machine may be configured to manage execution of the algorithm.

Classical computing resources 110 may execute classical portion 614, and quantum computing resources 114 may execute quantum portion 710, according to some embodiments. For example, classical computing resources 110 and quantum computing resources 114 may generate results 712 of algorithm execution. In some embodiments, classical computing resources 110 and quantum computing resources 114 may send results 618 to algorithm execution management system 106. In some embodiments, results 712 may be incorporated into the container for subsequent retrieval by consumer 103. In other embodiments, results 712 may be incorporated into the container for subsequent executions of the algorithm.

Algorithm execution management system 106 may send results 714 to web server 140 based on results 712 provided by classical computing resources 110 and quantum computing resources 114, according to some embodiments. In some situations, post-processing code included in the container may modify at least a portion of results 618 to generate results 714. For example, particular ranges of results 712 may be removed. As another example, particular types of results 712 may be filtered.

Web server 140 may provide results 716 of algorithm execution to consumer 103 based on results 714 provided by algorithm execution management system 106, according to some embodiments. For example, web server 140 may generate a user interface to display results 716 to consumer 103. As another example, web server 140 may send one or more files that include results 716.

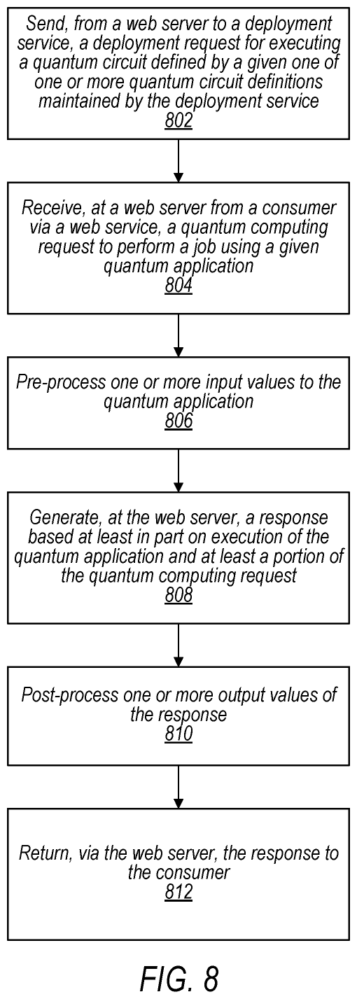

FIG. 8 illustrates a flowchart diagram for a method 800 for a web server providing access to execution of an algorithm in accordance with a quantum circuit, according to some embodiments. The method 800 may be implemented one or across one or more computing devices. The method 800 may be implemented by web server 140 of FIG. 1 or 5 or by web service 142 of FIG. 1, 4, or 5, according to various embodiments.

The method 800 may include sending, from a web server to a deployment service, a deployment request for executing a quantum circuit defined by a given one of one or more quantum circuit definitions maintained by the deployment service, at 802. The deployment server may correspond to published quantum circuit deployment service 130 of FIG. 1 or 4-6. The deployment request may indicate the quantum circuit to be deployed. For example, the deployment request may include an identifier for a container that includes the quantum circuit.

The method 800 may also include receiving, at the web server from a consumer via a web service, a quantum computing request to perform a job using a given quantum application, at 804. The consumer may send the quantum computing request to the web server according to a URI or URL that exposes the web service to the consumer. For example, the consumer may access the URI or URL via the Internet or other network connection to establish communications between the consumer and the web service. In some embodiments, the web server may send a deployment request to an algorithm execution management system to cause deployment of the quantum circuit on or across classical computing resources and quantum computing resources. The classical computing resources and quantum computing resources may execute respective portions of the algorithm for the quantum circuit.

The method 800 may also include pre-processing one or more input values for the response, at 810. In some embodiments, the input values may be modified to improve performance of the quantum circuit. The input values may be modified to limit particular types of inputs to be processed by the quantum circuit.

The method 800 may further include generating, at the web server, a response based at least in part on execution of the quantum application and at least a portion of the quantum computing request, at 808. In some embodiments, the classical computing resources and quantum computing resources may provide a response to the deployment request that includes results of the algorithm execution. The results may be provided from the classical computing resources and quantum computing resources to the algorithm execution management system, which in turn may provide the results to the web server.

The method 800 may also include post-processing one or more output values of the response, at 810. For example, the web server may interpret the response and apply a post-processing function the response. In some embodiments, the response may be processed to be human-readable. In other embodiments, the response may be processed to be formatted in a data format for subsequent processing by another system for the consumer. In other embodiments, specified values or types of values may be removed from the response.

The method 800 may conclude by returning, via the web server, the response to the consumer, at 812. In some embodiments, the web server may transmit the response via the connection established based on the URI or URL.

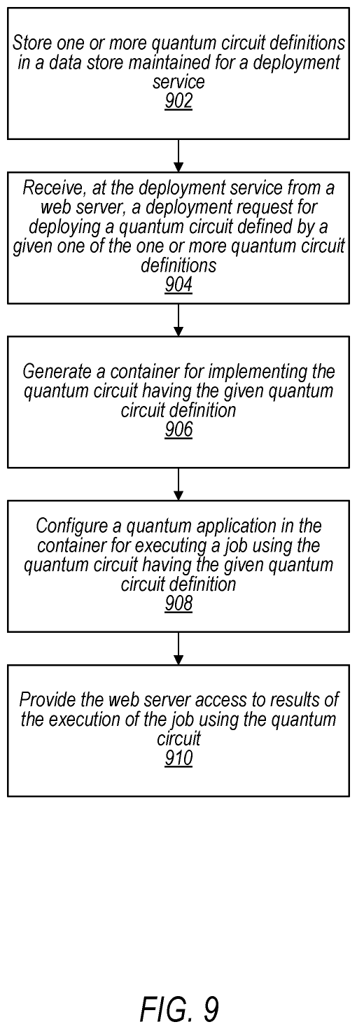

FIG. 9 illustrates a method 900 for a deployment service to implement a quantum circuit, according to some embodiments. The deployment service may be implemented on or across one or more computing devices, according to some embodiments. The deployment service may correspond to published quantum circuit deployment service 130 of FIG. 1, 4, or 5, according to various embodiments.

The method 900 may include storing one or more quantum circuit definitions in a data store maintained for a deployment service, at 902. In some embodiments, at least one of the quantum circuit definitions may be provided by various publishers, such as publisher 102. In other embodiments, at least one of the quantum circuit definitions may be provided by a quantum computing service, such as quantum computing service 104.

The method 900 may also include receiving, at the deployment service from a web server, a deployment request for executing a quantum circuit defined by a given one of the one or more quantum circuit definitions, at 904. The web server may receive requests from consumers, such as consumer 103, to deploy quantum circuits. In some embodiments, the quantum circuits may be deployed on-demand in response to requests from consumers. In some embodiments, the web server may be implemented according to method 800 of FIG. 8.

The method 900 may further include generating a container for implementing the quantum circuit having the given quantum circuit definition, at 906. The container may correspond to algorithm container 112 of FIG. 1, according to some embodiments. In some embodiments, the container may include pre-processing code, the quantum circuit or the quantum circuit definition, and post-processing code. The pre-processing code may perform tasks prior to execution of the quantum circuit. For example, the pre-processing code may modify one or more input values to the quantum circuit. The post-processing code may perform tasks after execution of the quantum circuit. For example, the post-processing code may modify one or more output values from the quantum circuit.

The method 900 may also include configuring a quantum application in the container for executing a job using the quantum circuit having the given quantum circuit definition, at 908. In some embodiments, the quantum application may include code implemented on or across classical computing resources and quantum computing resources. For example, the quantum application may include a classical code portion for execution on classical computing resources, and the quantum application may include a quantum code portion for execution on quantum computing resources.

The method 900 may conclude by providing the web server access to results of the execution of the job using the quantum circuit, at 910. In some embodiments, the execution of the job may cause results of the quantum application to be returned to the deployment service. In some embodiments, the deployment service may provide the results to the web server by providing a URI or URL to a storage destination that stores the results. In other embodiments, the deployment service may provide the results as a package that is transmitted to the web server.

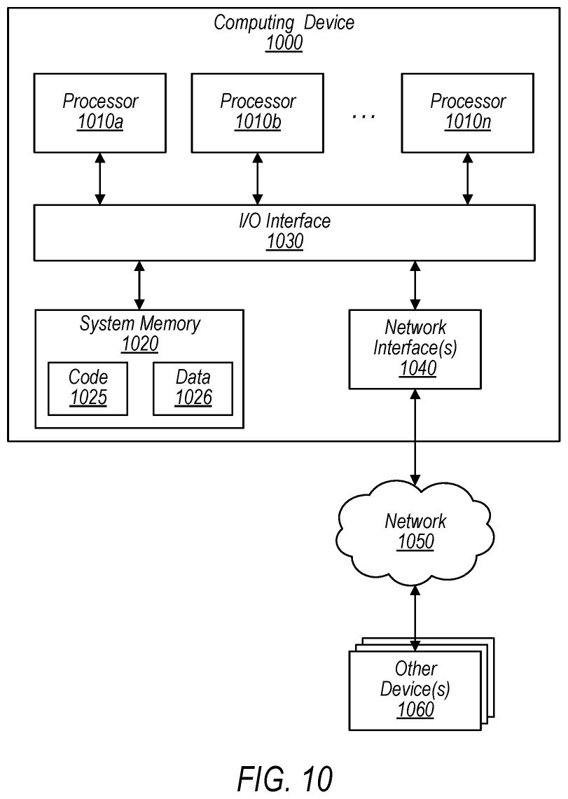

FIG. 10 shows an example computing device to implement the various techniques described herein, according to some embodiments. For example, in one embodiment, the algorithm execution management system described above may be implemented by a computer device, for instance, a computer device as in FIG. 10 that includes one or more processors executing program instructions stored on a computer-readable storage medium coupled to the processors. In the illustrated embodiment, computer system 1000 includes one or more processors 1010 coupled to a system memory 1020 via an input/output (I/O) interface 1030. Computer system 1000 further includes a network interface 1040 coupled to I/O interface 1030. While FIG. 10 shows computer system 1000 as a single computing device, in various embodiments a computer system 1000 may include one computing device or any number of computing devices configured to work together as a single computer system 1000.

In various embodiments, computer system 1000 may be a uniprocessor system including one processor 1010, or a multiprocessor system including several processors 1010 (e.g., two, four, eight, or another suitable number). Processors 1010 may be any suitable processors capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

System memory 1020 may be one embodiment of a computer-accessible medium configured to store instructions and data accessible by processor(s) 1010. In various embodiments, system memory 1020 may be implemented using any non-transitory storage media or memory media, such as magnetic or optical media, e.g., disk or DVD/CD coupled to computer system 1000 via I/O interface 1030. A non-transitory computer-accessible storage medium may also include any volatile or non-volatile media such as RAM (e.g. SDRAM, DDR SDRAM, RDRAM, SRAM, etc.), ROM, etc., that may be included in some embodiments of computer system 1000 as system memory 1020 or another type of memory. Further, a computer-accessible medium may include transmission media or signals such as electrical, electromagnetic, or digital signals, conveyed via a communication medium such as a network and/or a wireless link, such as may be implemented via network interface 1040. In the illustrated embodiment, program instructions (e.g., code) and data implementing one or more desired functions, such as the algorithm execution management system described above in FIGS. 1-9, are shown stored within system memory 1030 as code 1025 and data 1026.

In one embodiment, I/O interface 1030 may be configured to coordinate I/O traffic between processor 1010, system memory 1020, and any peripheral devices in the device, including network interface 1040 or other peripheral interfaces. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. Also, in some embodiments some or all of the functionality of I/O interface 1030, such as an interface to system memory 1020, may be incorporated directly into processor 1010.

Network interface 1040 may be configured to allow data to be exchanged between computer system 1000 and other devices 1060 attached to a network or networks 1050. In various embodiments, network interface 1040 may support communication via any suitable wired or wireless general data networks, such as types of Ethernet network, for example. Additionally, network interface 1040 may support communication via telecommunications/telephony networks such as analog voice networks or digital fiber communications networks, via storage area networks such as Fiber Channel SANs, or via any other suitable type of network and/or protocol.

In some embodiments, system memory 1020 may be one embodiment of a computer-accessible medium configured to store program instructions and data as described above for FIG. 1-8. Generally speaking, a computer-accessible medium may include non-transitory storage media or memory media such as magnetic or optical media, e.g., disk or DVD/CD coupled to computer system 1000 via I/O interface 1030. A non-transitory computer-accessible storage medium may also include any volatile or non-volatile media such as RAM (e.g. SDRAM, DDR SDRAM, RDRAM, SRAM, etc.), ROM, etc., that may be included in some embodiments of computer system 1000 as system memory 1020 or another type of memory. Further, a computer-accessible medium may include transmission media or signals such as electrical, electromagnetic, or digital signals, conveyed via a communication medium such as a network and/or a wireless link, such as may be implemented via network interface 1040.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various systems and methods as illustrated in the figures and described herein represent example embodiments of methods. The systems and methods may be implemented manually, in software, in hardware, or in a combination thereof. The order of any method may be changed, and various elements may be added, reordered, combined, omitted, modified, etc.

Various modifications and changes may be made as would be obvious to a person skilled in the art having the benefit of this disclosure. It is intended that the embodiments embrace all such modifications and changes and, accordingly, the above description to be regarded in an illustrative rather than a restrictive sense.

What is claimed is:

1. A system, comprising:
a web server configured to:
receive, from a consumer via a web service, a quantum computing request to perform a job using a given quantum application;
generate a response based at least in part on execution of the quantum application and at least a portion of the quantum computing request; and
return the response to the consumer; and
a deployment service configured to:
store one or more quantum circuit definitions in a data store;
receive, from the web server, a deployment request for executing a quantum circuit defined by a given one of the one or more quantum circuit definitions;
generate a container for implementing the quantum circuit having the given quantum circuit definition;
configure a quantum application in the container for executing a job using the quantum circuit having the given quantum circuit definition; and
provide the web server access to results of the execution of the job using the quantum circuit.

2. The system of claim 1, further comprising:
a quantum processing unit comprising one or more quantum computing devices, wherein the quantum processing unit is configured to:
receive, from the deployment service, the quantum application; and
configure the quantum processing unit according to the quantum circuit having the given quantum circuit definition.

3. The system of claim 2, wherein the quantum processing unit is further configured to:
execute the job using the quantum circuit according to the quantum application; and
generate the results of the execution of the job using the quantum circuit.

4. The system of claim 1, wherein the web server is further configured to:
host the web service; and
provide access to the web service according to a uniform resource identifier.

5. The system of claim 1, wherein the container further comprises:
a pre-processing function configured to provide inputs to the quantum application; and
a post-processing function configured to modify the results of the execution of the job, wherein the modified results are provided to the web server.

6. A method, comprising:
receiving, by a quantum circuit deployment service, a deployment request for executing a quantum circuit defined by a quantum circuit definition, wherein the quantum circuit definition is one of a plurality of quantum circuit definitions maintained by the quantum circuit deployment service;
generating a container for implementing the quantum circuit having the quantum circuit definition;
configuring a quantum application in the container for executing a job using the quantum circuit having the quantum circuit definition;
providing access to results of the execution of the job using the quantum circuit.

7. The method of claim 6, further comprising:
sending the container to quantum computing resources configured to execute the job using the quantum circuit;
instructing the quantum computing resources to execute the job using the quantum circuit; and
receiving, from the quantum computing resources, the results of the execution of the job.

8. The method of claim 6, wherein the container further comprises:
a pre-processing function configured to provide inputs to the quantum application; and
a post-processing function configured to modify the results of the execution of the job, wherein the modified results are provided to the web server.

9. The method of claim 8, further comprising:
in response to the results of the execution of the job, applying the post-processing function to modify the results.

10. The method of claim 6, further comprising:
receiving, from a publisher, a publishing request indicating the quantum circuit having the given quantum circuit definition.

11. The method of claim 6, further comprising:
storing the container to a container repository.

12. The method of claim 10, further comprising:
causing the container to be transmitted from the container repository to quantum computing resources configured to execute the job using the quantum circuit.

13. The method of claim 6, further comprising:
mapping the container to a uniform resource identifier; and
sending, to the web server, an indication of the uniform resource identifier for the container.

14. One or more computer-readable storage media storing instructions that, when executed on or across one or more processors, cause the one or more processors to:
in response to a deployment request from a web server for executing a quantum circuit defined by a quantum circuit definition, generate a container for implementing the quantum circuit having the quantum circuit definition, wherein the quantum circuit definition is one of a plurality of quantum circuit definitions maintained by the quantum circuit deployment service;
configure a quantum application in the container for executing a job using the quantum circuit having the quantum circuit definition; and
provide access to results of the execution of the job using the quantum circuit.

15. The one or more computer-readable storage media of claim 14, further comprising instructions that, when executed on or across the one or more processors, cause the one or more processors to:
send the container to quantum computing resources configured to execute the job using the quantum circuit;
instruct the quantum computing resources to execute the job using the quantum circuit; and
receive, from the quantum computing resources, the results of the execution of the job.

16. The one or more computer-readable storage media of claim 14, wherein the container further comprises:
a pre-processing function configured to provide inputs to the quantum application; and
a post-processing function configured to modify the results of the execution of the job, wherein the modified results are provided to the web server.

17. The method of claim 6, further comprising:
receiving, from a publisher, a publishing request indicating the quantum circuit having the given quantum circuit definition.

18. The one or more computer-readable storage media of claim 14, further comprising instructions that, when executed on or across the one or more processors, cause the one or more processors to:
store the container to a container repository.

19. The one or more computer-readable storage media of claim 18, further comprising instructions that, when executed on or across the one or more processors, cause the one or more processors to:
cause the container to be transmitted from the container repository to quantum computing resources configured to execute the job using the quantum circuit.

20. The one or more computer-readable storage media of claim 14, further comprising instructions that, when executed on or across the one or more processors, cause the one or more processors to:
map the container to a uniform resource identifier; and
send, to the web server, an indication of the uniform resource identifier for the container.
